(19) United States
(12) Patent Application Publication
(10) Pub. No.: US 2018/0255744 A1
(43) Pub. Date: Sep. 13, 2018

(54) Variable Slot Length Adjustment Vent

(71) Applicant: Nevin Wagner, Manheim, PA (US)

(72) Inventor: Nevin Wagner, Manheim, PA (US)

(21) Appl. No.: 15/917,188

(22) Filed: Mar. 9, 2018

Related U.S. Application Data
(60) Provisional application No. 62/469,676, filed on Mar. 10, 2017.

(51) Int. Cl. A01K 1/00; F24F 13/14

(52) U.S. Cl. CPC A01K 1/0064; F24F 2007/004; F24F 13/14

(57) ABSTRACT

A vent with an adjustable baffle is disclosed. As the baffle is rotated away from the frame of the vent a corresponding opening is formed though which air may flow. The vent further has features which constrict the width of the opening in response to how far the baffle is opened. When the baffle is partially opened, these constricting features block a portion of the vent opening resulting in an opening of a certain width. The baffle can be opened further to a point beyond the constricting feature so that a wider vent opening is created. The design allows for more, and easier control of air flow in a system and can increase the distance air coming though the vent moves into the space before it descends.

### FIELD OF THE INVENTION

The subject matter of this application pertains to devices and methods for controlling air flow in buildings. More precisely, the subject matter of this application pertains to adjustable vents. Even more precisely, the subject matter of this application pertains to adjustable air flow vents in which the width of the vent opening is dependent on the degree of displacement of the baffle. The subject matter of this application may be of particular value to livestock housing environments such as, e.g., poultry houses.

### BACKGROUND

Any sealed system containing animals will have a gradual decrease in oxygen concentration and an increase in carbon dioxide concentration as a function of the metabolic needs of the contained animals. Eventually, the oxygen level will drop too low to support animal life. Man-made structures such as poultry houses are far from perfectly sealed systems and are generally air-permeable enough to support animals housed inside. However, even if a poultry house had large open windows ensuring adequate oxygen levels, the inconsistent airflow would present other problems.

Airflow if responsible for much more than just ensuring adequate oxygen levels, and just like a fan in a bedroom on a hot summer night, the airflow in a room or building removes excess heat and humidity.

Accordingly, poultry houses do not simply have a completely passive, open window air-circulation system and the airflow is determined by a negative pressure system. A series of fans blow air out of the poultry house and the resulting negative pressure pulls in air from a battery of upwardly opening vents along the walls. The airflow is therefore determined by two factors, the pressure caused by air being expelled and the amount of outside air that can flow through the vents.

The airflow in a building such as livestock housing largely controls both the temperature radiated by the animals and other sources, and the humidity exhaled by the animals and from evaporation. Other problems that may be caused by poor airflow such as the spread of disease and low oxygen levels are secondary to temperature and humidity control and airflow rates sufficient for temperature and humidity control are likely sufficient for disease mitigation and maintaining oxygen concentration.

In warmer weather, more rapid air flow will help keep the temperature and humidity within the livestock house from rising too high;.in cold weather, the airflow requirements are more complicated.

Cold air is more dense than warm air, so incoming cold air will tend to drop to the floor and push warm air from the heating system and the birds being towards the ceiling. To keep the birds warm, cold air should blow into the building with sufficient speed so that it moves (or is “thrown”) above the animals and toward the center of the building. The incoming air begins to warm as it moves toward the center of the room, which is also where the warmest air tends to collect so by the time the newly introduced air reaches the floor it has warmed and the temperature decrease at the floor has been minimized.

The throw of incoming air is most dependent on the temperature difference between inside and outside the house, the negative pressure, and the amount the vents are opened. Air density is correlated with air temperature, so air becomes more dense as it becomes colder. Therefore when the difference between inside and outside temperatures is greatest, the relative air densities are greatest, and incoming cold air will tend to fall before it can be warmed. That tendency can be mitigated by increasing the speed of the entering air by increasing the negative pressure. Adjusting the vents to manipulate the speed of incoming air works to a point, but can have unexpected effects.

When air enters through openings in standard vents of less than about an inch, the air tends to travel along the wall instead of being thrown toward the center of house. Much larger openings of 2-3 inches or more cause the air to be initially thrown in the right direction but the speed of the incoming air through a opening of that size can be too slow to reach far before dropping. Openings of 1-3 inches are therefore typically advised for getting the best throw, although then the volume of cold air being pulled into a house where each vent is open 1-3 inches may drop the temperature in the house too low and require greater expenditures for heating.

One solution would be to only open some of the inlets 1-3 inches and leave other inlets closed. Unfortunately that solution has its own problems. Such selective opening is at odds with common practices which, in order to reduce the cost and time needed to manipulate the vents' baffles, employ a single opening means to open or close a battery of vents in unison. Further, in poultry houses with multiple batteries of vents, opening a few can cause unusual air flow patterns such as hot or cold spots, or areas of greater air velocity.

In order for optimal air distribution, the vents should be sufficiently open to cause adequate throw towards the center of the room, but not so widely open that the volume of air coming in is greater than what can be warmed with minimal expenditure. Further, an optimal air inlet system would have somewhat equally spaced vents and large batteries of vent baffles could be adjusted in unison.

### SUMMARY

The subject matter of this application is related to ventilation devices and methods. More precisely, the subject matter of this application pertains to vents and vent baffles for use in animal housing, particularly poultry housing.

The subject matter of this application pertains to vents and vent baffles comprising one or more structural features which allow the baffle to be adjusted so that an opening though which air can flow is present, but this opening does not extend across the entire length of the baffle. Opening the baffle further exposes a opening extending further across the baffle's length though which air can flow. The partial opening allows for the vent or vents to be opened enough for air to move into the poultry house with sufficient throw towards the building's ceiling, but without allowing air across the entire length of the baffle to enter. In this way, sufficient air is able to enter the building so that it can warm above the birds before reaching the floor, but air flow is also restricted so that entering cold air does not overpower the heating capacity of the poultry house.

The subject matter of this application is able to control airflow without the need for more complicated baffle opening technology than that already commonly in use in poultry houses.

### BRIEF DESCRIPTION OF THE DRAWINGS:

FIG. 1 is a view of an embodiment of the vent with a closed baffle.

FIG. 2 is a view of a first embodiment of the vent with a partially opened baffle.

FIG. 3 is a view of a first embodiment of the vent with a fully opened baffle.

FIG. 4 is a view of baffle and restrictors of the first embodiment of the vent, separated from the frame.

FIG. 5 is a view of a second embodiment of the vent with a partially opened baffle.

FIG. 6 is a view of a second embodiment of the vent with a fully opened baffle.

FIG. 7 is a view of the vent frame and a restrictor of the second embodiment of the vent, separated from the baffle, and with the restrictor retracted inside the vent frame as it would be if the baffle was in its closed position.

FIG. 8 is a view of the vent frame and a restrictor of the second embodiment of the vent, separated from the baffle, and with the restrictor fully expanded into the space formed by the baffle being in its fully open position.

FIG. 9 is a view of a third embodiment of the vent with a closed baffle.

FIG. 10 is a view of a third embodiment of the vent with a partially opened baffle.

FIG. 11 is a view of a third embodiment of the vent with a fully opened baffle.

### DETAILED DESCRIPTION OF THE DRAWINGS:

The following description and referenced drawings illustrate embodiments of the application's subject matter. They are not intended to limit the scope. Those familiar with the art will recognize that other embodiments of the disclosed method are possible. All such alternative embodiments should be considered within the scope of the application's claims.

Each reference number consists of three digits. The first digit corresponds to the number of the figure in which that reference number is first shown. Reference numbers are not necessarily discussed in the order of their appearance in figures.

As used here, a “wall” is a substantially solid structure that blocks nearly all air from passing though it. A “vent” is structure which, when mounted in a hole in a wall, can control the passage of air though said space via one or more air blocking means. A “frame” is a the portion of a vent which contacts the physical structure surrounding said hole in a wall. A “baffle” is a movable item such as a slat, which may restrict the flow of air though an associated vent. In most embodiments, the baffle is attached to the frame of the vent. A “vent opening” is the portion of the vent which is not blocked by another structure though which air flows. A “restrictor” is a structure attached to a baffle or a frame which lengthens or shortens the width of the vent opening as a function of the position of the baffle. A “restrictor means” is comprised of at least one restrictor.

There are preferred embodiments in which the restrictor means is stationary and also in which the restrictor means is hinged and can move when the baffle is adjusted. Either type of restrictor means may be attached the frame or to the baffle. Accordingly, the drawings are just examples of preferred embodiments and should not be construed to limit the scope of the claims to just the illustrated designs. Drawings are not to scale.

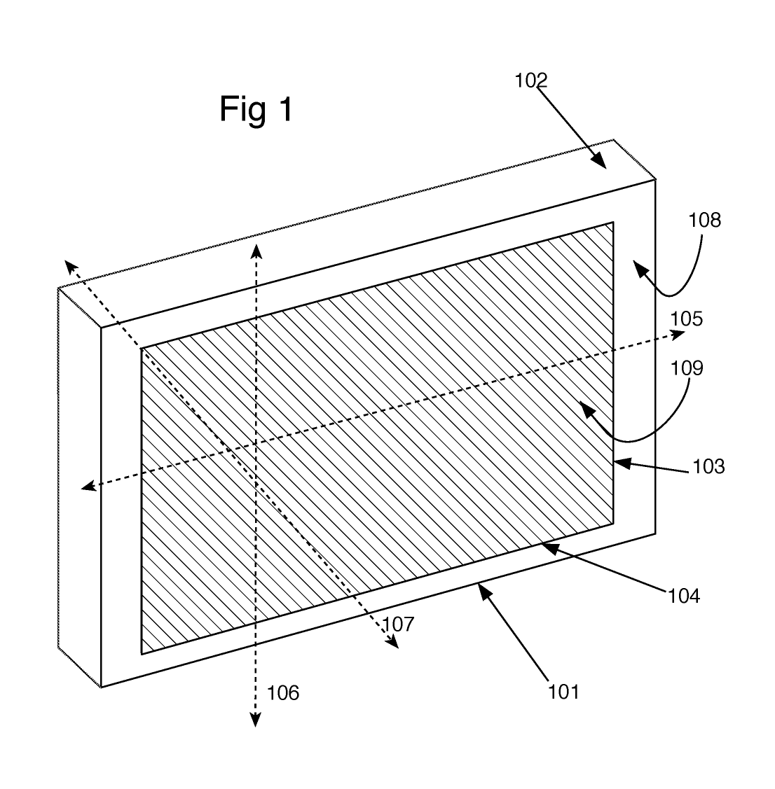

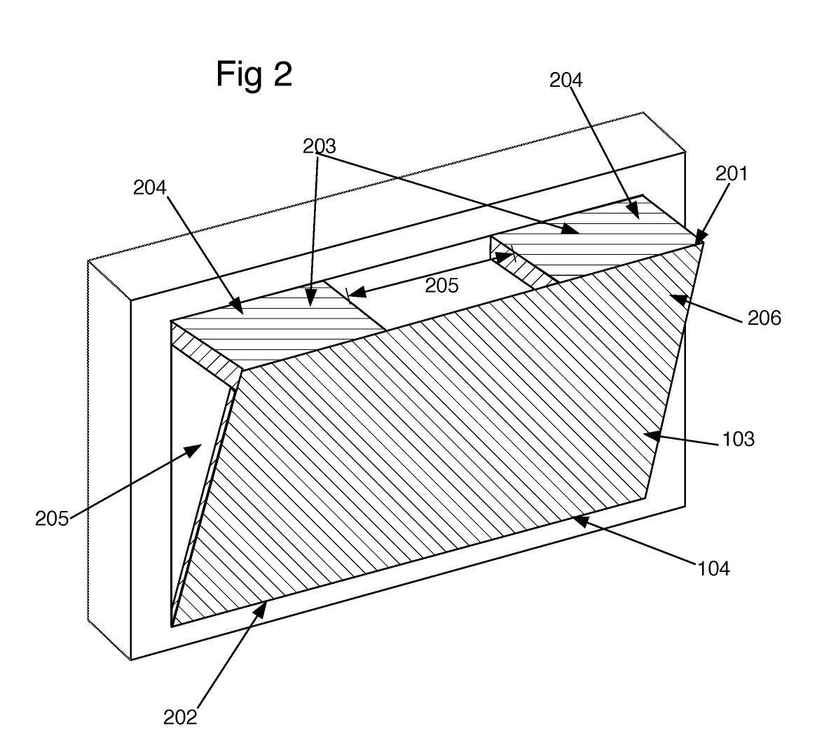

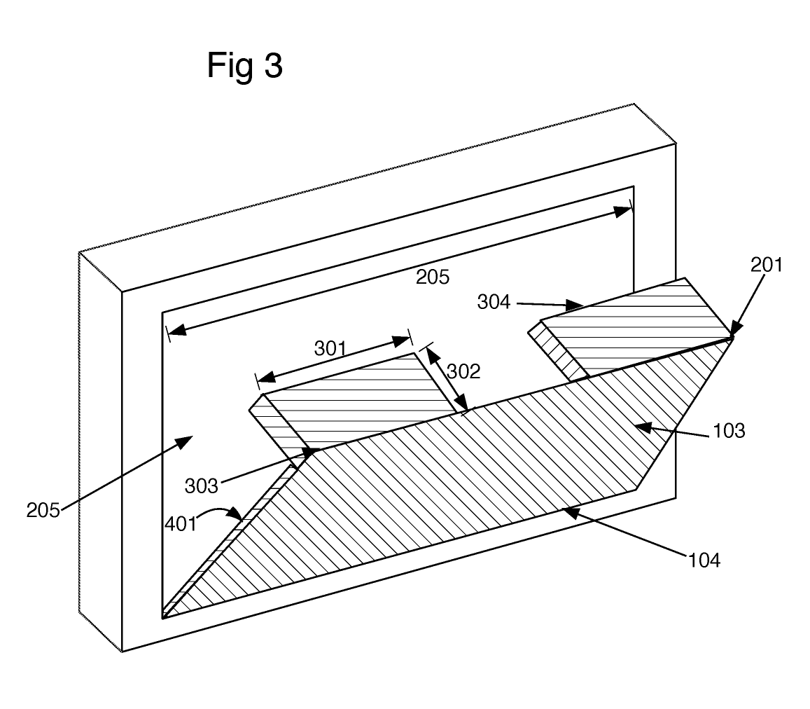

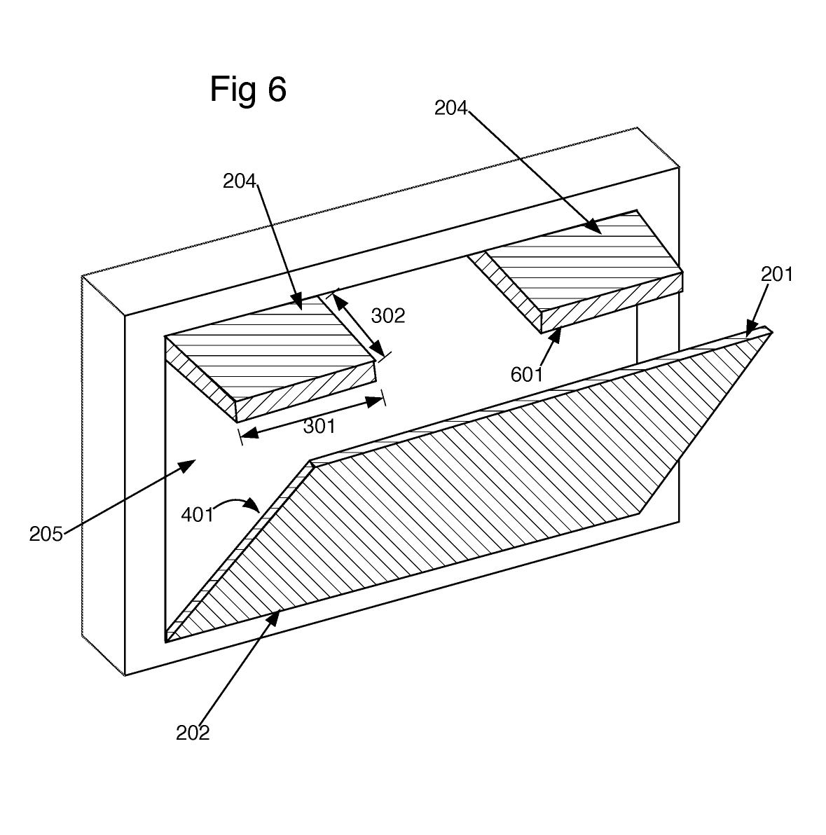

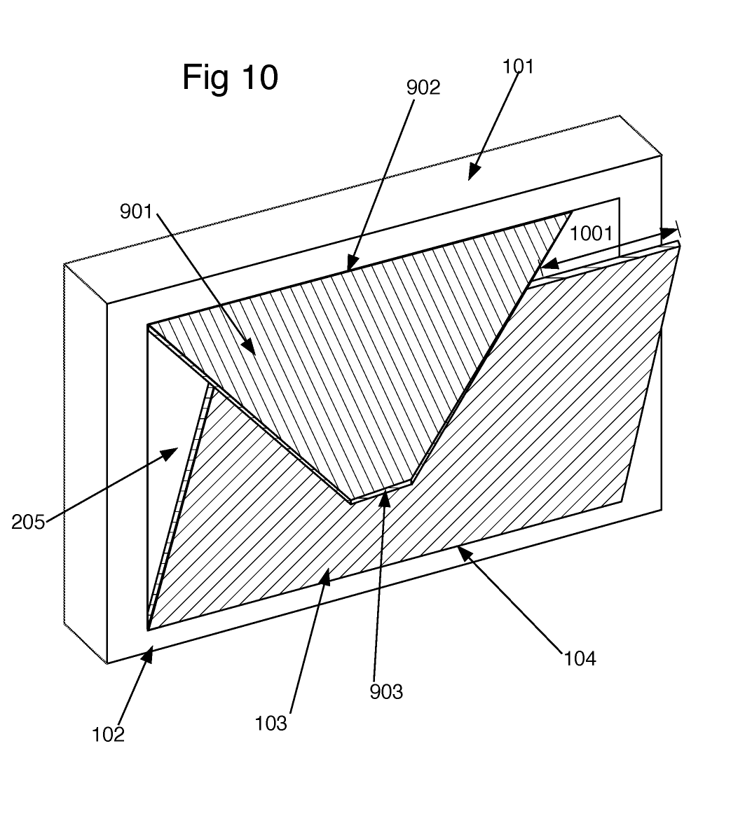

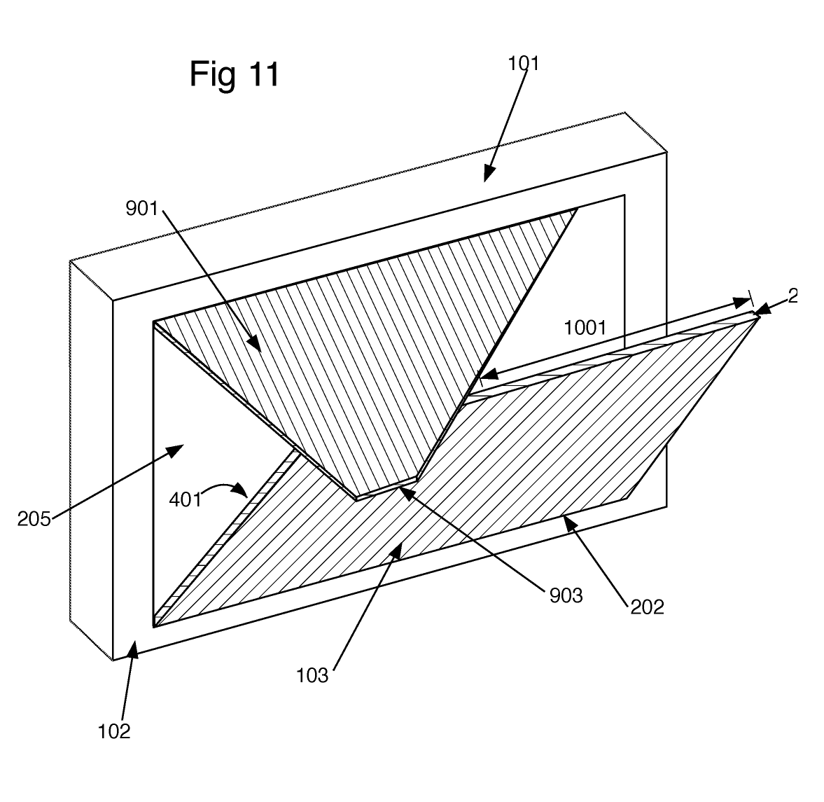

A vent (101) is associated with a surrounding frame (102). A baffle (103) is attached to the frame and can move in relation to the frame. The position of the baffle in relation to the frame determines whether the vent is closed (FIGS. 1, 9), partially open (FIGS. 2, 5, 10), or fully open (FIGS. 3, 6, 11). In most preferred embodiments, the baffle is attached to the frame along a pivot point (104) such as a hinge.

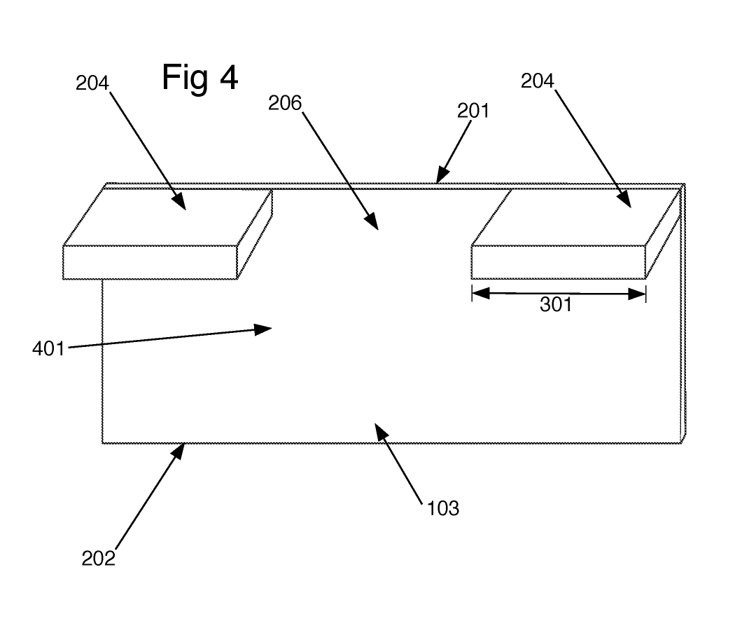

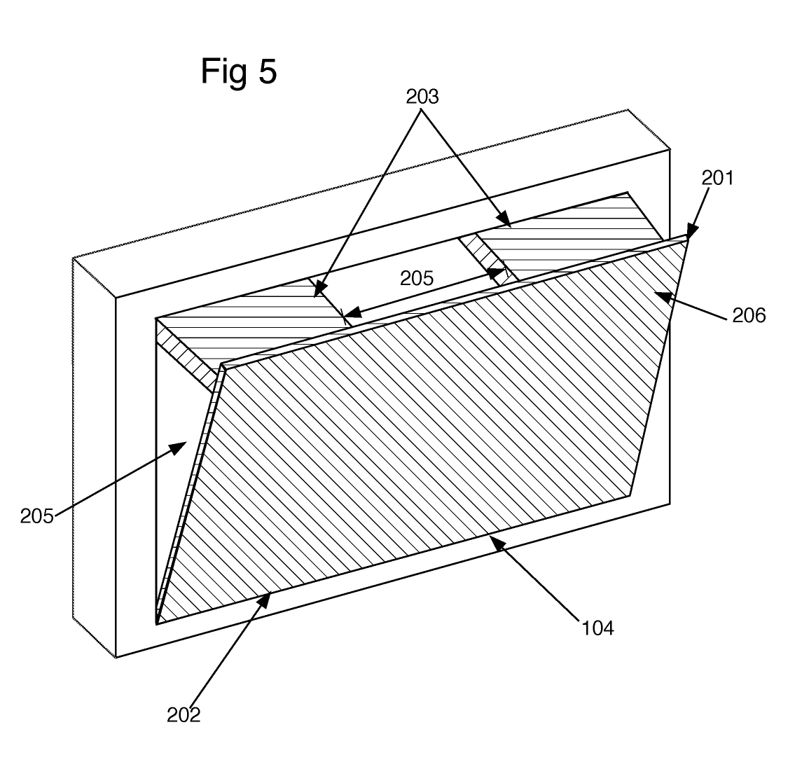

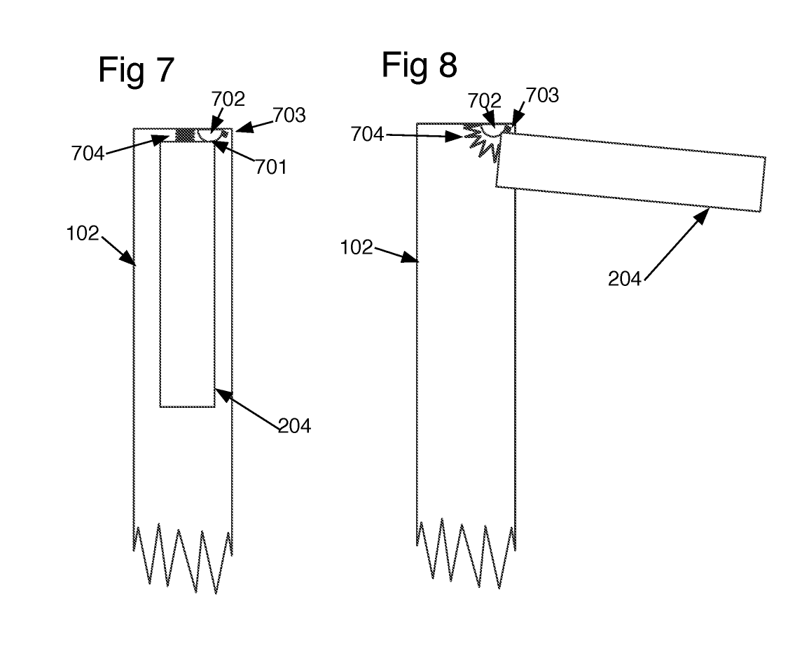

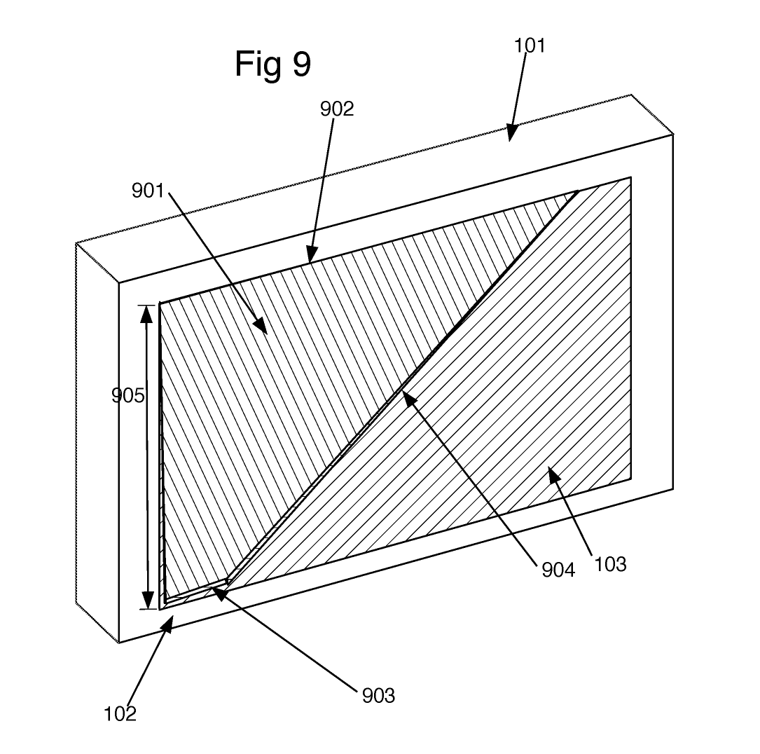

In certain preferred embodiments, the baffle comprises a restrictor means (FIGS. 1, 2, 3, and 4). In other embodiments, a restrictor means is attached to the frame.(FIGS. 5, 6, 7, and 8).

The baffle may have an effectively infinite number of positions, however, we define “closed” as the position where the baffle is fully closed and prevents nearly all air from moving through the vent and “fully open” as the position when the baffle is open as fully as it can be. Between the closed and fully open positions is at least one “intermediate position” in which the vent is partially open and where air may pass though the vent but the vent opening is constrained by the restrictor means.

In a first preferred embodiment, a vent (101) comprises a frame (102) and a baffle (103). Said frame comprising a outer face (108). The baffle comprises a longitudinal X axis (105), a Y axis (106), a Z axis (107), a first edge (201) a second edge (202), a top portion (206), an inner face (401) and an outer face (109). The second edge is attached to the hinged region on the frame. In response to work being done on the baffle, the baffle rotates and it's first edge moves further from, or closer to, the frame. When the baffle is in an intermediate position or fully open, a vent opening is formed between the frame and the baffle. The first edge of the baffle comprises a restrictor means (203) comprising at least one restrictor (204). Said restrictor having as width (301), a depth (302), a first edge (303) and a second edge (304). The first edge of the restrictor is attached to, or continuous with, a portion of the first edge of the baffle. The first edge of the restrictor extends from the first edge of the baffle into the frame such that partially opening the baffle creates a vent opening (205) across part of the baffle's X axis which allows air to flow through said vent opening, while at the same time said restrictor means prevents air from flowing though that portion of the first edge of the baffle connected to, or continuous with, the restrictor means. Further opening the baffle by causing the baffle's first edge to move farther from the frame such that the restrictor means are fully extracted from the frame, creating a vent opening across the entire x axis of the baffle. Alternatives to this embodiment may have the restrictor attached to the frame instead of the baffle.

In a second preferred embodiment, the baffle comprises a longitudinal X axis (105), a Y axis (106), a Z axis (107), a first edge (201) a top portion (206), a second edge (202), an inner face (401) and an outer face (109). The second edge is attached to the hinged region (104) on the frame. In response to work being done on the hinge, the baffle rotates and it's first edge moves further from, or closer to, the frame. When the baffle is in an intermediate position or fully open, a vent opening is formed between the frame and the baffle. The frame of the baffle comprises a restrictor means (203) comprising at least one restrictor (204). Said restrictor having as width (301), a depth (302), a first edge (701) and a second edge (601). The first edge of the restrictor is attached to, or continuous with, a portion of the frame. The restrictor means further comprises a restrictor movement means (702). In a most preferred embodiment, the restrictor movement means is a hinge and when the baffle is closed the restrictor means is retracted inside the frame. As the baffle is moved from closed to an intermediate position, the restrictor means pivots about the hinge (702), and constricts the width of the resulting vent opening. The movement of said hinge is constrained by a means such as a pin (703) such that the restrictor means doesn't pivot throughout the entire path of the baffle as the baffle is moved from an intermediate position to its fully open position. In this way, the angle between the restrictor means and the vent frame is kept to less than 90 degrees, so the restrictor means can be pushed back into the frame by the baffle. Moving the baffle from an intermediate position to its closed position causes the baffle to contact the restrictor means and push the restrictor means to its retracted position. In some preferred embodiments, said restrictor movement means further comprises a mechanical means (704) which causes the movement of the restrictor means when said baffle moves from the closed position of the baffle to an intermediate position of the baffle. In a preferred embodiment, the mechanical means is a spring which contracts when the baffle is closed and extends as the baffle is opened. In other embodiments, there is no mechanical means, and gravity causes the restrictor means to move when the baffle position in changes. Such embodiments are preferred for vents mounted on the ceiling. Alternatives to this embodiment may have the restrictor attached to the baffle instead of the frame.

In yet another embodiment, the baffle has a longitudinal X axis (104), a transverse Y axis (105), a Z axis (106), a first edge (201) and a second edge (202). The second edge is attached to the pivot point (104) of the frame. In response to work being done on the hinge, the baffle rotates and it's first edge moves further from, or closer to, the frame. When the baffle is in an intermediate position or fully open, a vent opening (1001) is formed between the frame and the baffle.

The frame of the vent comprises a restrictor (901). Said restrictor having a first edge with a width (902), a second edge with a width (903), an intermediate width area (904), and a depth (905). The first edge of the restrictor is attached to, or continuous with, a portion of the frame. Said width of the first edge of the restrictor is greater than said second width, and the intermediate width area decreases from the first edge to the second edge along the depth of the baffle forming a incline between said first width and said second width. As the baffle is moved from its closed position to its fully open position, the restrictor initially restricts airflow along the width of the second edge of the restrictor. As the baffle is further moved towards its fully open position, the area of the vent opening blocked by said restrictor as compared to the area of the vent opening unblocked by said restrictor decreases and air flow increases through the vent opening. In other alternative designs of this embodiment, the restrictor has a plurality of intermediate widths or “steps” instead of a incline. Other embodiments may have said restrictor mounted on the baffle. Yet other embodiments may have said restrictor capable of movement about an axis instead of having a fixed position.

In the drawings there is a lateral gap (205) shown between the at least partially open baffle and the frame. This gap is present to better show the inside of the vent. In practice this lateral gap may be blocked to further constrain airflow. The presence of such a gap blocking means is not part of the invention.

The subject matter of this application discloses a novel and useful design for a vent. Such a vent may be useful in several applications, although it may be most useful in livestock housing, particularly poultry houses.

I claim:

1. A vent comprising a frame, a baffle, and a restrictor means,
a. said frame comprising a first axis, a second axis, a third axis, and an outer face parallel to said first axis,
b. said baffle comprising a top portion, a bottom, a first axis, a second axis, a third axis, an inner face, an outer face, a first edge, and a second edge, said second edge of the baffle being attached to the frame at a pivot point and capable of motion on said pivot point,
c. said restrictor means comprising at least one restrictor, said baffle further comprising a closed position when the outer face of the baffle is parallel to, and in the same plane as the outer face of said frame, at least one intermediate position in which the baffle is rotated on the pivot point to create an intermediate vent opening between said first edge of the baffle and the vent frame, said first vent opening having a width less than the width of the baffle, and a fully open position in which the baffle is rotated on the pivot point to create a second vent opening being substantially as wide as the width of the baffle.

2. The vent of claim 1 in which said restrictor means comprises at least one structure extending from the top portion of the inner face of the baffle such that said structure is within the frame when said baffle is in the closed position, and moves into the space between said first edge of the baffle and the vent frame, created by the baffle pivoting from the closed position of the baffle to an intermediate position.

3. The vent of claim 1 in which said restrictor means further comprises a restrictor movement means which moves the restrictor means in response to movement of the baffle.

4. The vent of claim 1 in which said restrictor means further comprises a restrictor movement means,
a. said restrictor movement means comprising a hinge connected to said frame,
b. said hinge having an axis and capable of rotating along said axis in response to movement of the baffle such that movement of the baffle from the closed position to an intermediate position causes the hinge to rotate and move said restrictor means into the space between the frame and the first edge of the baffle.

5. The vent of claim 1 in which said restrictor means further comprises a restrictor movement means,
a. said restrictor movement means comprising a hinge connected to said frame, and a mechanical means,
b. said hinge having an axis and capable of rotating along said axis in response to work done on said restrictor movement means by the mechanical means in response to movement of the baffle such that movement of the baffle from the closed position to an intermediate position causes the hinge to rotate and move said restrictor means into the space between the frame and the top of the baffle.

6. The vent of claim 1 in which said restrictor means further comprises a restrictor movement means,
a. said restrictor movement means comprising a hinge connected to said frame, and a mechanical means,
b. said mechanical means comprising a spring which is compressed when said baffle is in the closed position and expands when the first edge of the baffle moves from the closed position toward an intermediate position.
c. said hinge having an axis and capable of rotating along said axis in response to work done on said restrictor movement means by the mechanical means in response to movement of the baffle such that movement of the baffle from the closed position to an intermediate position causes the hinge to rotate and move said restrictor means into the space between the frame and the top portion of the baffle, and movement of the baffle from an intermediate position to the closed position causes the spring to compress and the hinge to rotate causing the restrictor means to retract into the frame.

7. The vent of claim 1 in which said restrictor means comprises a trapezoid flap connected to the frame by a hinge, said trapezoid flap resting on the top portion of the baffle when said baffle is in an intermediate position and blocking a portion of the space between the first edge of the baffle and the frame.
